(19) United States
(12) Patent Application Publication
(10) Pub. No.: US 2016/0082660 A1
(43) Pub. Date: Mar. 24, 2016

(54) Method for the production of customer-specific components

(71) Applicant: SCHUNK GMBH & CO. KG SPANN-UND GREIFTECHNIK, Lauffen am Neckar (DE)

(72) Inventors: Andreas Schuster, Wuestenrot/Neulautern (DE); Ralf Becker, Marbach (DE); Matthias Poguntke, Eberstadt (DE)

(21) Appl. No.: 14/436,091

(22) PCT Filed: Oct. 21, 2013
(86) PCT No.: PCT/EP2013/071929

§ 371 Date: Nov. 24, 2015

(30) Foreign Application Priority Data
Oct. 19, 2012 (DE) 10 2012 219 137.2

(51) Int. Cl. B29C 67/00; G05B 19/4099

(52) U.S. Cl. CPC B29C 67/0088; G05B 19/4099; G05B 2219/35134; G05B 2219/49007; B33Y 50/02

(57) ABSTRACT

Method of designing and producing a customer-specific component for clamping and/or gripping an object, in particular within the scope of an Internet-based access portal, having the following steps: providing CAD data of the object to be gripped and/or clamped by the user; generation of CAD data of the customer-specific component from the CAD data of a CAD blank of the customer-specific component and the CAD data of the object to be clamped and/or gripped such that the CAD data of the customer-specific component have, at least in sections, a negative surface of the object to be clamped and/or gripped; production of the customer-specific component using the CAD data of the customer-specific component by means of a generative production method.

This application is the national stage of PCT/EP2013/071929, filed Oct. 21, 2013 and claims Paris convention priority from DE 10 2012 219 137.2, filed Oct. 19, 2012.

### BACKGROUND OF THE INVENTION

The invention concerns a method for designing and producing a customer-specific component to clamp and/or grip an object, in particular within the scope of an Internet-based access portal. The invention also concerns such a customer-specific component.

Users working in the field of clamping and gripping technology, i.e. who are dealing with clamping and/or gripping of objects, often face the problem that the objects to be clamped and/or gripped cannot be clamped or gripped with standard gripping jaws or standard gripping fingers. For this reason, each customer-specific component must be individually adjusted to the clamping or gripping systems used by the customers, wherein the customer-specific components are then produced from CAD data by means of a machining production method. In this connection, it is at first required to laboriously generate CAD data for the individual gripping fingers or clamping jaws, wherein the components are then e.g. milled. This procedure is, however, particularly time-consuming and extremely expensive.

For this reason, it is the underlying purpose of the present invention to provide a method for designing and producing a customer-specific component, wherein the customer-specific component should be capable of production in a fast, simple and inexpensive manner.

### SUMMARY OF THE INVENTION

This object is achieved by a method comprising the features of the independent claim. The method has the following steps: providing CAD data of the object to be gripped and/or clamped by the user; automatic generation of CAD data of the customer-specific component from the CAD data of a CAD blank of the customer-specific component and the CAD data of the object to be clamped and/or gripped such that at least sections of the CAD data of the customer-specific component comprise a negative surface of the object to be clamped and/or gripped; producing the customer-specific component using the CAD data of the customer-specific component by means of a generative production method.

A user may thereby upload CAD data of an object to be gripped and/or clamped via an Internet portal onto a server, in particular, from a local computer, i.e. for example from home or from a company. The CAD data of the customer-specific component can then be generated from the CAD data of the object to be clamped and/or gripped uploaded by the user and the CAD data of the CAD blank. The CAD data of the customer-specific component generated in this fashion may then comprise, at least in sections, a negative surface of the object to be clamped and/or gripped. This is advantageous since it allows simple and reliable gripping or clamping of the object to be clamped and/or gripped in the area of the negative surface by such a customer-specific component. The customer-specific component can then be produced from the CAD data of the customer-specific component by means of a generative production method. The generative production method is advantageously Additive Manufacturing. Additive Manufacturing is one of the most inexpensive and fastest generative production methods, since Additive Manufacturing allows e.g. production in layers of a component of any contour from polyamide. For this reason, the customer-specific components can be produced quickly, easily and at low cost from the generated CAD data of the customer-specific component.

The object to be clamped and/or gripped is advantageously a rotationally symmetrical object. However, it is also feasible that the object to be clamped and/or gripped is not a rotationally symmetrical object.

In one advantageous embodiment of the method, the CAD data of the customer-specific component are generated by volume-superimposition of the CAD data of the CAD blank and the CAD data of the object to be clamped and/or gripped. The CAD data of the object to be clamped and/or gripped can thereby be subtracted, in particular, from the CAD data of the CAD blank, wherein it may be provided, in particular, that superimposition or subtraction is performed to such an extent that a sufficiently large negative surface can be ensured for forming a gripping or contact surface for gripping or clamping of the object.

In another advantageous manner, the CAD blank for the customer-specific component can be selected prior to generation of the CAD data of the customer-specific component. In this connection, more than one CAD blank may be available. The user may then advantageously select the appropriate CAD blank from a plurality of different CAD blanks that are available for the respective clamping or gripping purpose. This is advantageous in that a CAD blank can be selected, thereby already taking into consideration the contour of the object to be clamped and/or gripped. This prevents formation of unnecessary large material thicknesses in the production step of the generative production method, at the same time preventing insufficient material thickness due to selection of a matching CAD blank.

In a further advantageous embodiment of the invention, the CAD blanks of the customer-specific components have configuration sections for forming the negative surface and coupling sections for connecting to the standard components. The coupling sections then enable attachment or connection of the customer-specific components to existing standard components of clamping and gripping technology. The coupling sections may thereby be provided as standard, wherein for generating the CAD data of the customer-specific component, only the configuration sections can be designed and adjusted to the component being clamped and/or gripped.

The user can advantageously select a standard component prior to selection of the CAD blank, wherein pre-selection of the CAD blank is performed as a reaction to the previous selection of the standard component. Selection of the standard component prior to selection of the CAD blank allows pre-selection of the CAD blank associated with the selected standard component, wherein the number of available CAD blanks can then be reduced in such a fashion that the user can decide more quickly and with a greater overview, which CAD blank to select.

In this connection, a chuck and/or a gripper can preferentially be selected as a standard component and a clamping jaw and/or a gripping finger can preferentially be selected as a CAD blank.

In a further advantageous embodiment of the method, the component to be clamped and/or gripped can be arranged by the user in a 3-dimensional CAD environment with respect to the CAD blank prior to generation of the CAD data of the customer-specific component. In case of a non-rotationally symmetrical object to be clamped and/or gripped, it is possible to advantageously define an optimum arrangement for the subsequent clamping and/or gripping. The generation of the CAD data of the customer-specific component with respect to the CAD blank may then be performed taking into consideration the arrangement of the object to be clamped and/or gripped in such a fashion that a negative surface can also be formed for non-rotationally symmetrical objects to be clamped and/or gripped, whereby an optimum gripping position can be defined.

In a further advantageous embodiment of the method, the CAD data of the customer-specific component can be controlled and individually changed by the user in a control step after generation of the CAD data. This control and change step allows the user to control the CAD data of the customer-specific component to such an extent that the production of erroneous customer-specific components is prevented. It allows e.g. prevention of producing components with insufficient wall thickness. It may be possible to inform the user in the control step about potentially critical sections of the customer-specific component in a CAD environment.

It is also advantageous for the CAD data of the customer-specific component to be storable after generation. Towards this end, the CAD data may be stored on a local computer or on a server. Storage of the CAD data of the customer-specific component allows repeated ordering of the customer-specific components such as e.g. gripping fingers or clamping jaws.

The above-mentioned object is also achieved by a customer-specific component comprising the features of claim 11. At least sections of such a component comprise a negative surface of an object to be clamped and/or gripped. This negative surface permits definition of a contact or gripping surface with the object to be clamped and/or gripped. The size of the contact surface may advantageously be selected such that safe clamping or gripping is ensured.

The component preferentially comprises coupling sections for connecting to standard components and gripping sections for clamping and/or gripping of the object. The coupling sections may thereby advantageously be used for connecting to already existing standard components such as e.g. grippers or chucks. The gripping sections comprise, in particular, the negative surface of the objects to be clamped and/or gripped.

The component is moreover advantageously a gripping finger and/or a bellows gripper and/or a clamping jaw. The customer-specific production of gripping fingers, bellows grippers or clamping jaws permits inexpensive customer-specific adjustment in the field of clamping and gripping technology. It is thereby also feasible to produce complete gripping systems comprising e.g. compensating units and swivel units within the scope of the configuration process by Additive Manufacturing.

The component is moreover advantageously produced from polyamide PA or metal. The production from polyamide PA ensures particularly inexpensive production, wherein production from metal provides particularly robust components.

Further details and advantageous embodiments of the invention can be extracted from the following description, which describes and explains in more detail the embodiment of the invention illustrated in the drawings.

In the drawing:

### BRIEF DESCRIPTION OF THE DRAWING

FIG. 1a shows a first part of a schematic flow chart of an embodiment of the inventive method;

FIG. 1b shows a second part of the flow chart of the embodiment of the inventive method in accordance with FIG. 1a;

FIG. 2 shows superimposition of CAD data of an object to be clamped and/or gripped and of a CAD blank of a customer-specific component; and

FIG. 3 shows inventive customer-specific components produced by the inventive method.

### DESCRIPTION OF THE PREFERRED EMBODIMENT

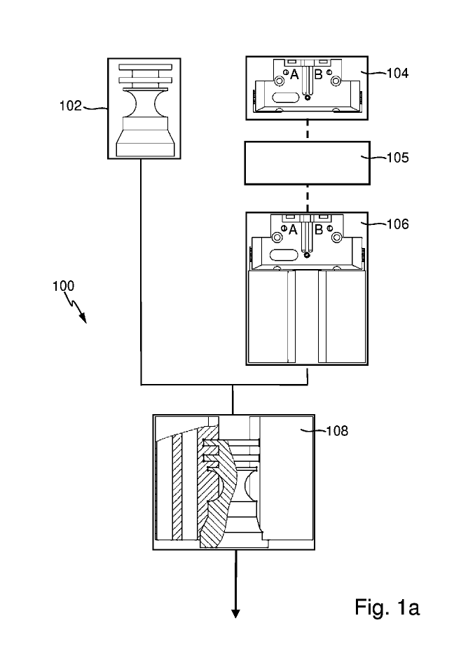

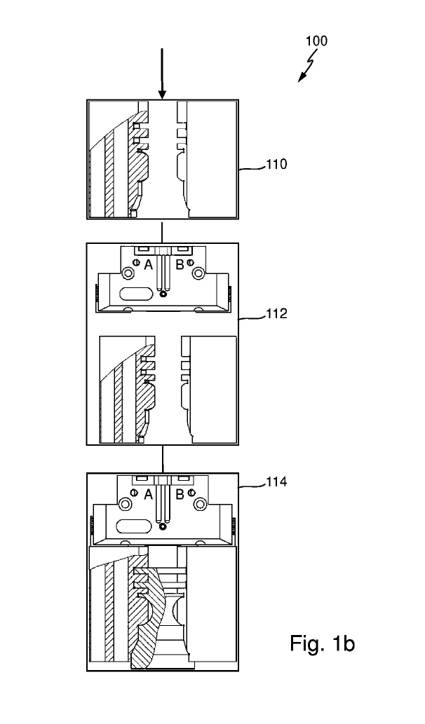

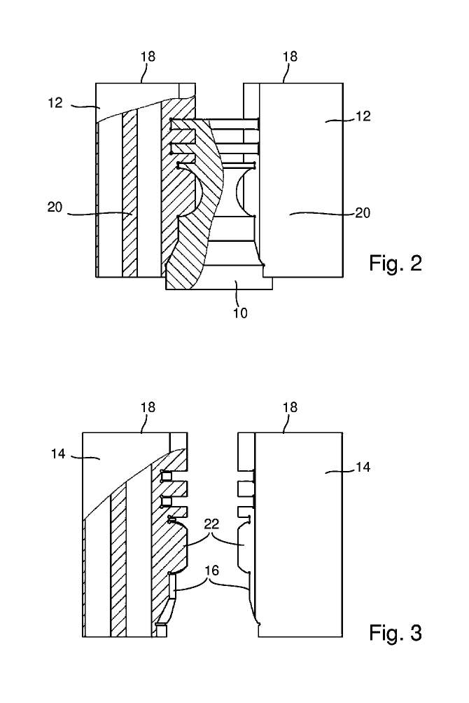

FIGS. 1a and 1b show an embodiment of the inventive method 100. In a first step 102, CAD data of an object 10 to be clamped and/or gripped, shown in FIG. 2, are provided e.g. by a user. It may be feasible for the user to upload the CAD data onto an Internet server from a local computer e.g. from home or from a company. In a component selection step 104, a user can select a standard component such as e.g. a chuck and/or a gripper. In response to the selection of the standard component by the user in the component selection step 104, a CAD blank 12 shown in FIG. 2 of a customer-specific component 14 shown in FIG. 3 is selected in an automatic pre-selection 105 from a plurality of different CAD blanks 12.

In a second step 106, the user may select a CAD blank 12 from the CAD blanks 12 selected in accordance with the automatic pre-selection. After provision 102 of the CAD data of the object 10 to be clamped and/or gripped in the first step 102 and selection of a CAD blank 12 of the customer-specific component 14 in the second step 106, the CAD data of the customer-specific component 14 are then automatically generated in a third step 108. The CAD data of the customer-specific component 14 are generated through volume superimposition of the CAD data of the CAD blank 12 of the customer-specific component 14 and the CAD data of the object 10 to be clamped and/or gripped in a third step 108.

Towards this end, the CAD blank illustrated in FIG. 2 has a coupling section 18 for connecting to a standard component such as a chuck or a gripper, and a configuration section 20 for customer-specific adjustment. The CAD data of the coupling sections 18 are not changed during generation of the CAD data of the customer-specific component 14 in the third step 108. The customer-specific components 14 illustrated in FIG. 3 consequently also comprise the coupling sections 18. The customer-specific components 14 can be mounted to the coupling sections 18 e.g. to a chuck or a gripper, wherein the coupling sections 18 are designed in such a fashion that the customer-specific components 14 can be connected to the standard components selected in the component selection step 104 in the region of the coupling sections 18 without further adjustment of the CAD data.

The volume superimposition in the third step 108 is performed in such a fashion that the CAD data of the customer-specific component 14 comprise, at least in sections, a negative surface 16, illustrated in FIG. 3, of the object 10 to be clamped and/or gripped, wherein the negative surface 16 is formed in the area of the configuration section 20. In particular, with rotationally symmetrical objects 10, this negative surface 16 provides a contact or gripping surface. In case of non-rotationally symmetrical objects 10, the CAD blank 12 may be aligned or arranged with respect to the object 10 e.g. in a 3-dimensional CAD environment prior to generation of the CAD data 108. It is, in particular, feasible for the user to control the data in an additional control step after generation 108 of the CAD data of the customer-specific component 14 in the third step 108.

After production of the customer-specific components 14 by a generative production method in a fourth step 110 illustrated in FIG. 1b, the customer-specific components 14 have gripping sections 22 in the area of the configuration sections 20, wherein the negative surface 16 for gripping and/or clamping of an object 10 is arranged in the area of the gripping sections 22.

The customer-specific components 14 can then be mounted to a gripper by means of the coupling sections 18 in a fifth step 112 e.g. as illustrated in FIG. 1b. Clamping and/or gripping of an object 10 using the customer-specific components 14 designed as gripping fingers is shown in a sixth step 114 in FIG. 1b. Production of the customer-specific components 14 that are designed as gripping fingers thus permits gripping of any object 10 with standard grippers.

1-16. (canceled)

17. A method of designing and producing, or of designing and producing using an internet-based access portal, a customer-specific component for clamping and/or gripping an object, the method comprising the steps of:
a) providing CAD data of the object to be gripped and/or clamped by the user;
b) automatically generating CAD data of the customer-specific component from CAD data of a CAD blank of the customer-specific component and CAD data of the object to be clamped and/or gripped such that the CAD data of the customer-specific component comprise, at least in sections, a negative surface of the object to be clamped and/or gripped; and
c) producing the customer-specific component using the CAD data of the customer-specific component by means of a generative production method.

18. The method of claim 17, wherein the CAD data of the customer-specific component are generated through volume super position of the CAD data of the CAD blank and the CAD data of the object to be clamped and/or gripped.

19. The method of claim 17, wherein the CAD blank for the customer-specific component is selected prior to generation of the CAD data of the customer-specific component.

20. The method of claim 17, wherein the CAD blank of the customer-specific component has configuration sections for forming the negative surface and coupling sections for connecting to standard components.

21. The method of claim 19, wherein, prior to selection of the CAD blank, a standard component is selected by the user, wherein pre-selection of the CAD blank is performed in response to a previous selection of the standard component.

22. The method of claim 20, wherein, prior to selection of the CAD blank, a standard component is selected by the user, wherein pre-selection of the CAD blank is performed in response to a previous selection of the standard component.

23. The method of claim 17, wherein a chuck and/or a gripper is selected as a standard component and a clamping jaw and/or a gripping finger is selected as the CAD blank.

24. The method of claim 17, wherein the object to be clamped and/or gripped is arranged in a 3-dimensional CAD environment with respect to the CAD blank prior to generation of the CAD data of the customer-specific component by a user.

25. The method of claim 17, wherein, after automatic generation of the CAD data in step b), the CAD data of the customer-specific component is controlled and individually changed by a user in a control step.

26. The method of claim 17, wherein the CAD data of the customer-specific component is stored after automatic generation thereof in step b).

27. A customer-specific component produced by the method of claim 17, the component comprising:
a negative surface of the object to be clamped and/or gripped;
coupling sections for connecting to standard components; and
gripping sections for clamping and/or gripping the object, wherein at least portions of said gripping sections have the negative surface of the object to be clamped and/or gripped.

28. The component of claim 27, wherein the component is a gripping finger, a bellows gripper and/or a clamping jaw.

29. The component of claim 27, wherein the component is produced from polyamide or metal.
